(19) United States
(12) Patent Application Publication
(10) Pub. No.: US 2022/0219849 A1
(43) Pub. Date: Jul. 14, 2022

(54) METHOD AND PACKAGING FOR CONSERVING A FOODSTUFF IN A HYDROGEN ATMOSPHERE

(71) Applicant: VIAWA GMBH, Hennef (DE)

(72) Inventors: Markus POHLHAUSEN, Hennef (DE); David SUTER, Hitenau (CH)

(73) Assignee: VIAWA GMBH, Hennef (DE)

(21) Appl. No.: 17/610,616

(22) PCT Filed: May 14, 2020
(86) PCT No.: PCT/EP2020/063418

§ 371 Date: Nov. 11, 2021

(30) Foreign Application Priority Data
May 16, 2019 (DE) 10 2019 112 844.7

(51) Int. Cl. B65B 31/02; B65B 25/00; A23L 3/3409

(52) U.S. Cl. CPC B65B 31/02; A23V 2002/00; A23L 3/3409; B65B 25/001

(57) ABSTRACT

The invention relates to a method (100) for preserving a foodstuff in a hydrogen atmosphere in a packaging (200) comprising an interior space (220) enclosed by a hydrogen-permeable and airtightly sealable casing (210), the interior space (220) comprising a foodstuff space (221) for receiving the foodstuff and a hydrogen space (222) for receiving hydrogen gas, the foodstuff space (221) and the hydrogen space (222) being at least gas-conductively connected to one another, and the casing (210) or a sleeve (230) surrounding the hydrogen space (222) being dimensionally stable at a negative pressure in the hydrogen space (222) relative to an environment of the packaging (200) of at least 100 mbar. The method comprises at least the following steps: filling (110) the foodstuff at least into the foodstuff space (221), introducing (120) hydrogen gas at least into the hydrogen space (222), airtightly sealing (130) the casing (210) after the filling (110) and introduction (120), and generating (140) a negative pressure at least in the hydrogen space (222) relative to an environment of the packaging (200). The invention further relates to a packaging for use in a method according to the invention and to such use.

### TECHNICAL FIELD

The invention relates to a method for preserving a foodstuff in a hydrogen atmosphere in a packaging having an interior space enclosed by a hydrogen-permeable and airtightly sealable casing, the interior space comprising a foodstuff space for receiving the foodstuff and a hydrogen space for receiving hydrogen gas, the foodstuff space and the hydrogen space being connected to one another at least in a gas-conducting manner, and the casing or a sleeve surrounding the hydrogen space being dimensionally stable at a negative pressure in the hydrogen space relative to an environment of the packaging of at least 100 mbar.

The invention further relates to a packaging of the aforementioned type.

### PRIOR ART

Hydrogen has an antioxidant effect and can provide a longer shelf life and fresher looking foodstuff for longer. Through its antioxidant effect, hydrogen can influence the redox potential of the foodstuff; this can be used, for example, in baby food in order to better replicate the properties of natural breast milk, which has a redox potential of up to −70 mV, in substitute products. The antioxidant effect of hydrogen can reduce or completely eliminate the need for other preservatives or antioxidants.

There are already commercial suppliers selling hydrogen-enriched water in cans and bags. So far, however, no solutions are known that can permanently retain hydrogen in foodstuff packaging, as hydrogen can diffuse through the materials of common packaging and thus escape, leading over time to a complete leakage of hydrogen which is dissolved in the foodstuff and/or which is present in the packaging in addition to the foodstuff.

Hydrogen-enriched water is usually filled in flexible bags or metal cans made of a material that inhibits hydrogen diffusion under ambient pressure. In the case of flexible bags, one or more thin metal foils are usually used to inhibit hydrogen diffusion. In order to increase shelf life, filling is either done gas-free so that the packaging is completely filled with hydrogen-enriched water (mostly for beverage cans) or with a small volume of hydrogen gas in addition to the hydrogen-enriched water (for film packaging).

Patent application US20180213825A1 describes a filling of hydrogen-enriched water into cans at atmospheric pressure or above atmospheric pressure, the cans being completely filled with the enriched water.

Hydrogen-enriched water can additionally be mixed with hydrogen gas bubbles for a longer shelf life. Nano or micro bubbles are usually used for this purpose, as they remain stable in water for longer than macroscopic bubbles.

The aforementioned options for filling hydrogen-enriched water only insufficiently delay the escape of hydrogen gas from the packaging and are therefore not able to ensure a permanent hydrogen enrichment of the water. According to US20180213825A1, the hydrogen content in water in existing packaging decreases by approximately 14% up to 75% within 6 months, depending on the type of packaging.

For environmental and sustainability reasons, single-use packaging should be avoided. Since all the packaging for hydrogen-enriched water on the market so far is single-use packaging, there is a need for alternative packaging methods in this field.

Hydrogen-enriched water is a health product and it is therefore important to keep this water as pure as possible. Therefore, in the development of packaging for hydrogen-enriched water, it is important to avoid plastic and resin materials as far as possible, from which, for example, plasticisers may pass into the water and which are found in film packaging and most cans on the inside, in contact with the packaged foodstuff. Glass bottles do not have an inner coating of plastic and therefore seem to be advantageous for keeping the water clean.

However, when glass bottles are filled completely or almost completely with, for example, water, the problem arises that the bottles may burst when heated due to the thermal expansion of the water, which poses a considerable safety risk, especially in the case of glass bottles, because of the resulting splinters. In addition, water filled in this way and enriched with hydrogen does not last long. According to our own tests, almost no more hydrogen can be detected in the water after approximately one month (remaining hydrogen content approximately 0.3 ppm).

### Technical Object

The object of the invention is to provide an economical, simple and safe method for the long-term, safe and environmentally sound preservation of a foodstuff in a hydrogen atmosphere and an economical packaging therefor.

### Technical Solution

The present invention relates to a method according to claim 1 which solves the technical object. The object is also solved by a packaging according to claim 9. Advantageous embodiments result from the dependent claims.

### DESCRIPTION OF THE EMBODIMENTS

A method according to the invention is used for preserving a foodstuff, for example hydrogen-enriched water, in a hydrogen atmosphere in a packaging.

The packaging comprises an interior space enclosed by a hydrogen-permeable and airtightly sealable casing, the interior space comprising a foodstuff space for receiving the foodstuff and a hydrogen space for receiving hydrogen gas, the foodstuff space and the hydrogen space being connected to one another at least in a gas-conducting manner. The foodstuff space and the hydrogen space may be connected to each other in a liquid-conducting manner, in particular in a manner that is conductive for the foodstuff. In particular, the hydrogen space and the foodstuff space may be directly adjacent to each other at at least one contact plane, i.e., without a physical barrier between the hydrogen space and the foodstuff space.

The casing and/or a sleeve surrounding the hydrogen space is dimensionally stable at a negative pressure in the hydrogen space relative to an environment of the packaging of at least 100 mbar, preferably at least 200 mbar, in particular at least 400 mbar, for example at least 600 mbar. The dimensional stability can be achieved, for example, by a sufficiently rigid material of the casing and/or sleeve, a sufficiently high material thickness, a suitable shape of the casing and/or sleeve, for example with beads, folds, corrugations and/or ribs for stiffening, and/or a support structure arranged in the casing and/or sleeve, for example by a grated cage.

If the foodstuff is granular, for example in the form of a loose powder, the foodstuff can support the casing so that it is dimensionally stable in a food-filled state, and the spaces between the foodstuff grains can form the hydrogen space.

Since the foodstuff space and the hydrogen space are at least gas-conductingly connected to each other, the same pressure prevails in both, and therefore, for the purposes of the invention, the expression “a negative pressure in the hydrogen space” is synonymous with the expression “a negative pressure in the hydrogen space and the foodstuff space”.

The sleeve may comprise a hollow body comprising, for example, a plastic, a metal and/or a glass, for receiving the hydrogen gas. A hollow body can receive a particularly large volume of hydrogen gas at a given weight and material cost.

The sleeve may comprise, in particular at least in its interior, an open-pored, solid foam, comprising for example an expanded material, a rigid foam, an aerogel and/or a metal foam, for receiving the hydrogen gas. A foam offers the advantage of improved mechanical stability compared to a hollow body, in particular against pressure acting on the foam from the outside.

The method comprises filling the foodstuff at least into the foodstuff space, introducing hydrogen gas at least into the hydrogen space, sealing the casing airtight, preferably after the filling and introduction, and creating a negative pressure at least in the hydrogen space relative to an environment of the packaging.

The hydrogen gas introduced into the hydrogen space is in gas-conducting contact with the foodstuff filled into the foodstuff space, so that the foodstuff is preserved by the hydrogen gas, and in particular a hydrogen content of a hydrogen-enriched foodstuff is maintained by the contact with the hydrogen gas.

The solution according to the invention of filling under a negative pressure in a packaging that is at least partially dimensionally stable solves the problem experienced with previous packaging and opens up new possible applications of the antioxidant properties of hydrogen for foodstuff preservation.

Surprisingly, hydrogen-enriched water bottled by the method according to the invention shows only a slight reduction in the hydrogen content of the water despite a hydrogen-permeable casing. This reduction can already be observed in the first month after filling, after which the hydrogen content remains constant for several months, in contrast to conventional filling methods. Compared to previous packaging, which continuously loses hydrogen, in the method according to the invention a rapid loss of hydrogen does take place initially up to a certain negative pressure in the hydrogen space, but thereafter the hydrogen loss slows down considerably and a hydrogen content of the foodstuff can be maintained over a longer period than in known methods. Depending on the materials used, a different temporal progression of the hydrogen loss and/or the negative pressure can result.

Due to the fact that hydrogen diffuses very easily through most materials, foodstuffs in common foodstuff packaging, for example beverage bottles, foodstuff cans or foodstuff jars, are usually surrounded by a hydrogen-permeable casing. Surprisingly, a hydrogen-permeable casing has proven to be advantageous in the method according to the invention. As a result of such a cover, part of the hydrogen gas filled in can escape from the airtightly sealed packaging, so that a negative pressure is created therein, or a set negative pressure is maintained.

To ensure that the hydrogen space is not compressed in the event of a negative pressure therein, which would reduce or completely balance out the negative pressure, the casing of the packaging and/or the sleeve is designed to be dimensionally stable. If, for example, water enriched with hydrogen is filled together with hydrogen gas in a previously conventional packaging, for example a film bag or a beverage can, the packaging does not withstand the resulting negative pressure and deforms. This leads to a complete escape of the hydrogen gas from the packaging.

In order to prevent gases other than hydrogen from entering the packaging in the event of a negative pressure, the casing is designed to be airtightly sealable. In particular, a material of the casing may be airtight, i.e. in particular airtight for nitrogen, oxygen, carbon dioxide and/or argon. “Airtight” in the sense of the invention means that within a typical storage period of, for example, 0.5 years to 2 years, a negative pressure of, for example, 100 mbar to 600 mbar in the packaging is not substantially reduced by penetrating components of the ambient air.

Many types of conventional foodstuff packaging, for example beverage bottles, cans or jars, have an airtightly sealable casing. For example, foodstuffs in jars are often filled under a negative pressure of, for example, 600 mbar relative to the ambient air, this negative pressure being maintained over the intended storage period of the preserves of, for example, two years.

Even with films as packaging material, an airtightly sealable casing which maintains its negative pressure over the intended storage period can be realised, as shown by commercially available foodstuffs packed in films under negative pressure, such as cereal grains or coffee beans.

The generated negative pressure is preferably from 50 mbar to 500 mbar, particularly preferably 100 mbar to 300 mbar. The generated negative pressure is preferably from 100 mbar to 900 mbar, in particular from 200 mbar to 800 mbar, for example from 400 mbar to 600 mbar. The generated negative pressure is preferably at least 100 mbar, in particular at least 200 mbar, for example at least 400 mbar.

The specified values of the negative pressure preferably relate to an equilibrium value, which the negative pressure approaches during the storage of the foodstuff in the packaging or at which the negative pressure stabilises. This equilibrium value can be reached, at least approximately, for example after a storage period of from 30 days to 600 days, in particular from 60 days to 500 days, for example from 100 days to 400 days, after sealing.

The casing of the packaging or the sleeve of the hydrogen space is preferably dimensionally stable at the respective negative pressure. Experiments have shown that a reduction of the hydrogen content in the foodstuff can be considerably slowed down or even prevented by a negative pressure in the stated value ranges. Furthermore, a negative pressure in the stated value ranges can be maintained with a packaging made of conventional materials over a typical storage period of, for example, 0.5 years to two years.

The generation of the negative pressure preferably comprises a diffusion of hydrogen gas through the casing into the environment of the packaging after the airtight sealing of the casing. In particular, the generation of the negative pressure can be performed exclusively by diffusing hydrogen gas through the casing into the environment of the packaging. This makes the method particularly simple, in particular because pumping gas out of the packaging is not necessary to generate the negative pressure. This is particularly advantageous for a home application of the method, as suitable devices for this pumping operation are not usually available here.

The generation of the negative pressure preferably comprises a cooling of the foodstuff and/or the hydrogen gas after the airtight sealing of the casing. By cooling the foodstuff, the hydrogen gas and/or air contained in the packaging and as a result of the associated reduction in volume, the negative pressure can be generated in a technically particularly simple manner, similarly to the hot filling of preserves.

The generation of the negative pressure preferably comprises pumping off a gas, preferably air, out of the interior space before the airtight sealing of the casing and preferably before the introduction of the hydrogen gas, the negative pressure at the time of sealing being preferably 50 mbar to 500 mbar, particularly preferably 100 mbar to 300 mbar. By pumping off a gas, a possible contamination of the foodstuff by constituents contained in the gas can be prevented. Preferably, the gas is pumped off before the foodstuff is filled. The pumping operation is advantageously carried out before the hydrogen gas is introduced, so that no hydrogen gas is lost as a result.

In a first embodiment of the method, the casing is dimensionally stable at a negative pressure in the interior space relative to an environment of the packaging of at least 100 mbar, and the foodstuff space and the hydrogen space are conductively connected to each other for the foodstuff. In this embodiment, filling the foodstuff comprises completely filling the interior space with the foodstuff, and introducing the hydrogen gas occurs after filling and comprises displacing the foodstuff from the hydrogen space.

This first embodiment is particularly suitable for liquid foodstuffs, for example water enriched with hydrogen. By first completely filling the interior space with the foodstuff, gases previously contained in the interior space that could impair the storability of the foodstuff are expelled. When the hydrogen gas is introduced, part of the foodstuff is displaced from the interior space so that the hydrogen space is filled with hydrogen gas.

In this first embodiment, the foodstuff space and the hydrogen space are preferably adjacent to each other via a contact plane without a physical barrier. The division of the interior space into foodstuff space and hydrogen space can be variable in time, for example depending on a filling level of the interior space with the foodstuff. This allows the packaging to have a particularly simple structure, for example comprising a standard beverage bottle.

In a second embodiment of the method, the sleeve enclosing the hydrogen space is dimensionally stable at a negative pressure in the interior space relative to an environment of the packaging of at least 100 mbar, and the sleeve tightly seals off the hydrogen space from the foodstuff space for the foodstuff. For example, the hydrogen space can be connected to the foodstuff space in a gas-conducting manner via a liquid-tight membrane or via a number of sufficiently small connecting openings, without the foodstuff being able to enter the hydrogen space from the foodstuff space.

In this second embodiment, the casing of the packaging can be flexible at least in portions, for example may consist of a film. This makes this embodiment particularly suitable for dimensionally stable foodstuffs, the shape of which can be adapted by an at least partially flexible casing, and which can be prevented from entering the hydrogen space relatively easily, for example by means of a grating.

By means of an at least partially flexible casing, a larger quantity of hydrogen gas can be introduced into the packaging, and the casing expands so that the foodstuff, which, for example, has not previously been enriched with hydrogen can be enriched with hydrogen. When hydrogen gas escapes from the casing after this has been sealed, the casing is compressed again, for example until it is in contact with a support structure and/or the foodstuff. Due to the dimensionally stable sleeve, hydrogen gas continues to remain in the hydrogen space in at least gas-conducting contact with the foodstuff, whereby a predetermined concentration of hydrogen in the foodstuff can be maintained over an intended storage period.

In this second embodiment, the introduction of the hydrogen gas comprises completely filling the interior space with the hydrogen gas, and the filling of the foodstuff occurs after the introduction and comprises displacing the hydrogen gas from the foodstuff space, with air being pumped out of the interior space preferably prior to the introduction, the sleeve being dimensionally stable.

By completely filling the interior space with hydrogen gas, in particular if air has previously been pumped out of it, it is ensured that no foreign substances that could impair the storability of the foodstuff remain in the interior space.

In a third embodiment of the method, the sleeve enclosing the hydrogen space is dimensionally stable at a negative pressure in the interior space relative to an environment of the packaging of at least 100 mbar, and the sleeve tightly seals off the hydrogen space from the foodstuff space for the foodstuff.

In this third embodiment, the casing of the packaging can be flexible at least in portions, for example consisting of a film. This makes this embodiment particularly suitable for dimensionally stable foodstuffs, to the shape of which an at least partially flexible casing can adapt, and which can be prevented from entering the hydrogen space relatively easily, for example by means of a grating.

In this third embodiment, the introduction of the hydrogen gas into the hydrogen space takes place after the foodstuff has been filled into the foodstuff space, preferably with air being pumped out of the interior space before the introduction, in particular before the filling.

As the introduction takes place after the filling, only a small amount of hydrogen gas is required, making the method particularly economical. The pumping operation also ensures that no foreign substances that could impair the shelf life of the foodstuff remain in the interior space. Pumping after filling is disadvantageous for foodstuffs that are already enriched with hydrogen before being filled into the packaging, as pumping may cause large parts of the enriched hydrogen to escape.

In any embodiment of the method, the introduction of the hydrogen gas preferably comprises a filling of a hydrogen-enriched foodstuff. By enriching the foodstuff, for example water, with hydrogen, the shelf-life of the foodstuff is improved and when the foodstuff is consumed, positive effects caused by the hydrogen may be experienced by the consumer.

After filling the enriched foodstuff, at least part of the hydrogen therefrom can pass into the hydrogen space, so that the aforementioned advantages of a hydrogen space filled with hydrogen gas result, even if a smaller amount of hydrogen gas is introduced separately. In particular, with a smaller amount of separately introduced hydrogen gas, a predetermined hydrogen concentration in the foodstuff can be achieved and maintained during a storage period.

The hydrogen enriched in the foodstuff may be dissolved and/or entrapped therein, for example in the form of hydrogen bubbles. The bubbles may in particular be nano or micro bubbles, which may increase the total content of hydrogen in the foodstuff above a solubility limit of the hydrogen in the foodstuff. Bubbles below a certain size, for example 20 μm in water, preferably below 20 μm, do not rise and can therefore remain stable in the foodstuff over a storage period thereof.

When filling a hydrogen-enriched foodstuff, the foodstuff is preferably saturated with hydrogen and/or contains no other gases. If the foodstuff is saturated with hydrogen, the positive effect of the hydrogen is particularly pronounced.

If the foodstuff does not contain other gases, potentially adverse interactions of other gases with the foodstuff are excluded for the preservation of the foodstuff and a smaller amount of hydrogen gas must be introduced to achieve and maintain a predetermined hydrogen concentration in the foodstuff during its storage period.

The foodstuff is preferably enriched with hydrogen and does not contain any gases other than hydrogen. Advantageously, the foodstuff should be degassed before enrichment with hydrogen, for example by heating the foodstuff.

The introduction of hydrogen gas is also possible in such a way that a source or a reservoir for hydrogen gas is located in the casing, which is preferably sealed under a negative pressure in the hydrogen space, which then generates or releases hydrogen gas inside the sealed casing.

The generation can be carried out, for example, by a suitable metal in contact with water, preferably with a catalyst. A chemical reaction can produce a metal oxide and/or hydroxide and hydrogen gas.

For example, the reservoir can contain pressurised compressed and/or liquefied hydrogen gas, which is released from the reservoir after the casing is sealed.

A packaging according to the invention is designed for preserving a foodstuff in a hydrogen atmosphere by a method according to the invention.

The packaging comprises an interior space enclosed by a hydrogen-permeable and airtightly sealable casing, the interior space comprising a foodstuff space for receiving the foodstuff and a hydrogen space for receiving hydrogen gas, and the foodstuff space and the hydrogen space being at least gas-conductively connected to each other.

In a filling position of the packaging, the hydrogen space is preferably located above the foodstuff space so that hydrogen gas introduced into the interior space collects in the hydrogen space due to a density difference between the hydrogen gas and the foodstuff, driven by gravity.

Features of the packaging may in particular be designed as described in conjunction with the method according to the invention, resulting in the effects mentioned therein.

The casing may be dimensionally stable under a negative pressure in the hydrogen space relative to an environment of the packaging of at least 100 mbar, preferably at least 200 mbar, in particular at least 400 mbar, for example at least 600 mbar, and may comprise a media exchange device for simultaneously introducing hydrogen gas through an inlet line into the hydrogen space and discharging foodstuffs through an outlet line from the interior space.

A casing that is stable under negative pressure with a media exchange device is particularly suitable for carrying out the method in the first embodiment described above. The fact that the hydrogen gas can be introduced and the, preferably liquid, foodstuff can be discharged, for example displaced by the hydrogen gas, at the same time renders the method particularly simple and prevents contamination of the interior space with foreign gases. This is particularly important for a home application of the method, where there is usually no possibility of surrounding the packaging with a hydrogen atmosphere when introducing the foodstuff.

In particular, the media exchange device eliminates the need to immerse a bottle filled with water with its filling opening facing downwards in a larger vessel filled with water in order to introduce hydrogen into the bottle there and to seal the bottle under water so that no foreign gases enter the bottle.

The casing may be flexible at least in portions, and a sleeve surrounding the hydrogen space may be dimensionally stable under a negative pressure in the hydrogen space relative to an environment of the packaging of at least 100 mbar, preferably at least 200 mbar, in particular at least 400 mbar, for example at least 600 mbar. The sleeve may comprise a hollow body and/or a solid foam, and may in particular be configured as described in conjunction with the method according to the invention.

A casing that is flexible at least in portions and has a dimensionally stable sleeve is particularly suitable for a method in the second or third embodiment described above, in particular for a substantially dimensionally stable foodstuff. In the case of a dimensionally stable foodstuff, a casing which is flexible at least in portions, for example a casing which consists of a film at least in portions, is advantageous because it can adapt to the shape of the foodstuff.

Furthermore, the packaging can be produced with less material if only the sleeve is dimensionally stable instead of the entire casing. Because the sleeve is dimensionally stable, when there is negative pressure in the hydrogen space this space is not compressed by the ambient pressure. Thus, the negative pressure is maintained and a loss of hydrogen gas from the hydrogen space is slowed down by the negative pressure, so that the foodstuff is preserved over a storage period of, for example, 0.5 to two years by the hydrogen gas remaining in the hydrogen space. In particular, a hydrogen content of a hydrogen-enriched foodstuff for example water, is preserved over the storage period.

The casing and/or the sleeve is preferably dimensionally stable under a negative pressure in the hydrogen space of at least 0.1 bar, preferably at least 0.2 bar, particularly preferably at least 0.3 bar, most preferably 1 bar. The higher the value of the negative pressure at which the casing or sleeve is dimensionally stable, the higher the amount of negative pressure that can be permanently generated in the hydrogen space. A high amount of negative pressure can particularly slow down a loss of hydrogen gas from the hydrogen space during storage of the foodstuff in the packaging, thereby increasing the maximum storage time of the foodstuff. The dimensional stability at a negative pressure of 1 bar is particularly advantageous if air is pumped out of the casing and/or the sleeve by means of a vacuum pump before the packaging is filled with a foodstuff and/or hydrogen.

The casing is preferably resistant to an overpressure in the interior space relative to an environment of the packaging of at least 0.5 bar, preferably at least 2 bar, particularly preferably at least 8 bar. For example, for sterilisation, it may be necessary to heat the packaging after filling the foodstuff and airtightly sealing the casing, which temporarily creates an overpressure in the interior space. To prevent the casing from being damaged in the event of overpressure, it is preferably designed to be resistant to overpressure, i.e. the casing is airtight and dimensionally stable in the event of overpressure or deforms only elastically so that it returns to its original shape when the overpressure decreases.

The sleeve preferably seals off the hydrogen space tightly, preferably liquid-tightly, from the foodstuff space for the foodstuff. This prevents the foodstuff from penetrating into the hydrogen space so that said space is completely available for receiving hydrogen gas.

The sleeve can, for example, be sealed off by a gas-permeable and liquid-tight membrane. Alternatively or additionally, the hydrogen space and the foodstuff space can be connected by a number of openings, in particular pores, which are so small that the foodstuff cannot pass through them.

The casing is preferably transparent at least in portions. By means of a transparent portion, it is advantageously possible to optically, in particular visually, check a condition of the foodstuff in the sealed casing. This represents a significant advantage over conventional packaging for foodstuffs containing hydrogen, since conventional packaging is usually made of sheet metal or plastic coated with metal in order to reduce diffusion of hydrogen out of the packaging and is therefore completely opaque.

The casing preferably consists substantially of glass and/or a plastic, preferably a plastic film. A casing made of glass has the advantage that glass does not release any foreign substances, for example plastic particles and/or plasticisers, into the foodstuff, which could impair its quality and/or shelf life. Furthermore, a casing made of glass can be easily reused or recycled, for example via existing deposit systems for glass bottles, thus reducing any environmental pollution caused by the packaging.

A casing made of plastic, in particular a plastic film, has the advantages of low manufacturing costs and low mass, which reduces costs and energy consumption when transporting the packaging.

The casing preferably comprises a filling opening, which can be airtightly sealed by a sealing means, for filling the foodstuff into the interior space. For example, the casing may comprise a commercially available beverage bottle having a filling opening for filling the beverage, the sealing means comprising the cap of the beverage bottle. If the casing comprises a plastic film, the sealing means may comprise, for example, a weld to seal a filling opening in the plastic film or between the plastic film and another component of the casing.

For example, the filling opening may form the inlet line of the media exchange device. The outlet line can be located separately from the filling opening in another region of the casing.

The outlet line preferably opens out into the hydrogen space adjacent to a contact plane between the hydrogen space and the foodstuff space. Here, the contact plane is preferably substantially horizontal in a filling position of the packaging, with the hydrogen space above and the foodstuff space below the contact plane. This allows foodstuff present in the hydrogen space to escape through the outlet line when the hydrogen gas is introduced, while foodstuff present in the foodstuff space remains there.

The media exchange device is preferably designed to be arranged in the filling opening in a state of the filling opening sealed by the sealing means. This allows the casing to be sealed with the sealing means while the media exchange device is located in the filling opening and allows the media exchange device to remain in the filling opening for storage of the foodstuff in the packaging. Not having to remove the media exchange device reduces the risk of contamination of the interior space with extraneous gases that could affect the shelf life of the foodstuff. It also simplifies the method sequence for filling the foodstuff.

For example, the media exchange device is configured such that it can be partially inserted into the filling opening while partially resting on an edge of the filling opening. The bearing portion of the media exchange device that rests on the neck of the bottle is preferably thin enough so as not to interfere with the application of the sealing means thereover to seal the filling opening.

By being able to arrange the media exchange device in the filling opening, a conventional packaging, for example a beverage bottle, can be retrofitted with the media exchange device to form a packaging according to the invention.

The media exchange device preferably comprises a stopper to be sealingly inserted into the filling opening, the stopper comprising an inlet opening for receiving the inlet line and an outlet opening for receiving the outlet line, the stopper preferably comprising at least one sealant for, preferably gas-tight, sealing between the stopper and the inlet line and/or the outlet line.

For insertion in a sealing manner, in particular in a sealing manner for air, the stopper may comprise an elastic material, for example a soft plastic or a rubber, for sealing contact with an edge of the filling opening. In particular, the stopper may comprise the elastic material. This prevents hydrogen gas or foodstuff from escaping uncontrollably from the interior space between an edge of the filling opening and the stopper during introduction of the hydrogen gas, or prevents foreign gases from entering the interior space.

The sealant preferably comprises an elastic material, for example a soft plastic or a rubber, for sealing contact with the inlet line and/or outlet line. The sealant may be formed integrally with the stopper, for example by the stopper being made of the elastic material, or may comprise a separate component, for example a ring seal or a sealing insert.

The inlet line and/or outlet line may be arranged in a fixed or removable manner in the inlet opening or outlet opening, respectively. In particular, it may be provided to remove the inlet line and/or outlet line from the stopper before sealing the filling opening with the sealant. If the inlet line and/or outlet line is removable, the sealant is preferably designed to seal between the particular line and the stopper. This prevents hydrogen gas or foodstuff from escaping in uncontrolled fashion from the interior space between the particular line and the stopper or prevents foreign gases from entering the interior space during the introduction of the hydrogen gas.

Preferably, the sealant is designed for sealing, preferably airtightly, the inlet opening and/or outlet opening when the corresponding line is removed. This prevents hydrogen gas or foodstuff from escaping in uncontrolled fashion from the interior space through the filling opening or prevents foreign gases from entering the interior space after the inlet line and/or outlet line has been removed and before the filling opening is sealed with the sealant.

A removable inlet line and/or outlet line may comprise a stop, in particular an adjustable stop, which ensures that the particular line is inserted into the stopper exactly to a predetermined depth.

The outlet line is preferably inserted or insertable into the stopper such that it opens out into the hydrogen space adjacently to a contact plane between the hydrogen space and the foodstuff space. In this case, the contact plane is substantially horizontal in a filling position of the packaging, with the hydrogen space above and the foodstuff space below the contact plane. This allows foodstuff present in the hydrogen space to escape through the outlet line when the hydrogen gas is introduced, while foodstuff present in the foodstuff space remains there.

Depending on how far away from the stopper the outlet line opens out into the interior space, a volume ratio between the hydrogen space and the foodstuff space is determined for a given geometry of the casing by a position of the contact plane within the interior space defined by the mouth. This volume ratio can be selected depending on a type or pre-treatment of the foodstuff in such a way that a sufficient quantity of hydrogen gas can be introduced into the hydrogen space for the intended storage period of the foodstuff.

By adjusting the distance of the mouth of the outlet line from the stopper, for example with the aid of the stop, the media exchange device can be used with differently shaped casings or for filling different foodstuffs with a correspondingly adapted volume ratio between hydrogen space and foodstuff space and thus an adapted quantity of hydrogen gas.

Preferably, the media exchange device comprises at least one valve for regulating a media flow and/or for defining a media flow direction through the inlet line and/or outlet line. Preferably, the inlet line comprises a check valve to prevent leakage of foodstuff or hydrogen gas from the interior space through the inlet line.

Preferably, the outlet line comprises a closable outlet valve so that, when the outlet valve is closed, an overpressure can be built up in the interior space by the hydrogen gas introduced through the inlet line, whereby, for example, the foodstuff can be enriched with a higher concentration of hydrogen. In particular, the outlet valve can be designed as a pressure relief valve which opens automatically when a predetermined overpressure is reached in the interior space, for example to prevent damage to the casing due to excessive overpressure.

The media exchange device preferably comprises a securing means for releasably securing the media exchange device to the casing. The securing means may, for example, comprise a thread for screwing onto or screwing into a matching counter-thread on the filling opening of the casing.

For example, if the casing comprises a common beverage bottle, the media exchange device may comprise a thread designed to be screwed onto the mating thread normally provided for the cap of the beverage bottle. In particular, the media exchange device may comprise a further mating thread onto which the cap may be screwed. Thus, the cap can be screwed onto the media exchange device screwed onto the beverage bottle to seal the filling opening of the beverage bottle while the media exchange device remains in the filling opening.

The invention also relates to a use of a packaging according to the invention in a method according to the invention for preserving a hydrogen-enriched foodstuff in the packaging.

### BRIEF DESCRIPTION OF THE DRAWINGS

Further advantages, objectives and properties of the invention are explained with reference to the following description and accompanying drawings, in which subject-matter according to the invention is shown in an exemplary manner. Features which at least substantially correspond in the figures with regard to their function may be denoted by the same reference signs, however, these features do not have to be referenced or explained in all figures.

FIG. 1 shows a schematic sectional drawing of a foodstuff preserved in a packaging by a method according to the invention.

FIG. 2 shows a schematic sectional drawing of a foodstuff preserved in a further packaging by a method according to the invention.

FIG. 3 shows a schematic sectional drawing of a foodstuff preserved by a conventional method in a conventional packaging 200.

FIG. 4 shows a schematic sectional drawing of a foodstuff preserved by a conventional method in a conventional packaging 200.

FIG. 5 shows a schematic sectional drawing of a foodstuff preserved in a further packaging by a method according to the invention.

FIG. 6 shows a schematic view of a foodstuff preserved in a further packaging by a method according to the invention.

FIG. 7 shows a schematic view of a packaging according to the invention.

FIG. 8 shows a schematic view of a further packaging according to the invention.

FIG. 9 shows a schematic view of a further packaging according to the invention.

FIG. 10 shows schematic side views of embodiments of a stopper of a packaging according to the invention.

FIG. 11 shows schematic representations of a stopper of a packaging according to the invention.

FIG. 12 shows schematic representations of a further stopper of a packaging according to the invention.

FIG. 13 shows schematic representations of a further stopper of a packaging according to the invention.

FIG. 14 shows a schematic sectional drawing of a packaging according to the invention.

FIG. 15 shows a schematic sectional drawing of a further packaging according to the invention.

FIG. 16 shows further schematic sectional drawing of the packaging from FIG. 13.

FIG. 17 shows a schematic representation of a method according to the invention.

FIG. 18 shows a hydrogen content of water preserved by a method according to the invention depending on a storage period.

FIG. 19 shows a pressure in a packaging of water preserved by a method according to the invention depending on a storage period.

FIG. 20 shows a hydrogen content of water preserved by a method according to the invention depending on a filled hydrogen volume.

FIG. 21 shows a hydrogen content of water preserved by a method according to the invention depending on a storage period.

FIG. 22 shows a pressure in a packaging of water preserved by a method according to the invention depending on a storage period.

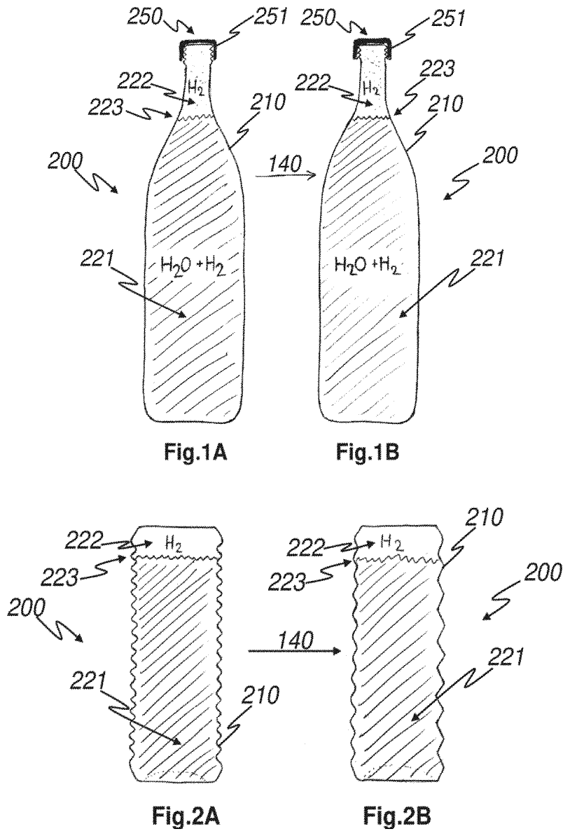

### FIG. 1

FIG. 1 shows a schematic sectional drawing of a foodstuff, for example water H₂O enriched with hydrogen H₂, preserved in a packaging 200 by a method 100 according to the invention.

The packaging 200 comprises an airtightly sealable casing 210, for example a known glass beverage bottle that is dimensionally stable under negative pressure, having a foodstuff filling opening 250. The casing 210 encloses an interior space comprising a hydrogen space 222 for containing hydrogen gas and a foodstuff space 221 for containing the foodstuff. In the example shown, the hydrogen space 222 and the foodstuff space 221 are directly adjacent to each other at a contact plane 223, without a physical barrier.

In the illustrated state, the filling 110 of the foodstuff into the foodstuff space 221 and the introduction 120 of hydrogen gas into the hydrogen space 222, as well as the airtight sealing 130 of the casing 210 with a sealing means 251, for example a cap matching the beverage bottle, have already been performed.

FIG. 1A shows a state before generating 140 a negative pressure in the hydrogen space 222, and FIG. 1B shows a state after generating 140 the negative pressure.

The illustrated casing 210 is dimensionally stable under the generated negative pressure, for example because it is made of glass. Therefore, the hydrogen space 222 is not compressed by the negative pressure. Since the casing 210 is airtightly sealed, no air can flow into the hydrogen space 222 from the outside, and therefore the negative pressure is maintained.

### FIG. 2

FIG. 2 shows a schematic sectional drawing of a foodstuff preserved in a further packaging 200 by a method 100 according to the invention.

FIG. 2 differs from FIG. 1 in that the casing 210 is not designed as a beverage bottle, but as a can. The casing 210 can be made dimensionally stable by a corrugated shape of its outer wall, for example as in known foodstuff cans, under a negative pressure in the hydrogen space 222. This allows the casing 210 to be made of a less rigid and thus thinner, lighter and/or more economical material, for example a metal sheet or a plastic.

Analogously to FIGS. 1A and 1B, FIG. 2A shows a state before generating 140 a negative pressure in the hydrogen space 222, and FIG. 2B shows a state after generating 140 the negative pressure.

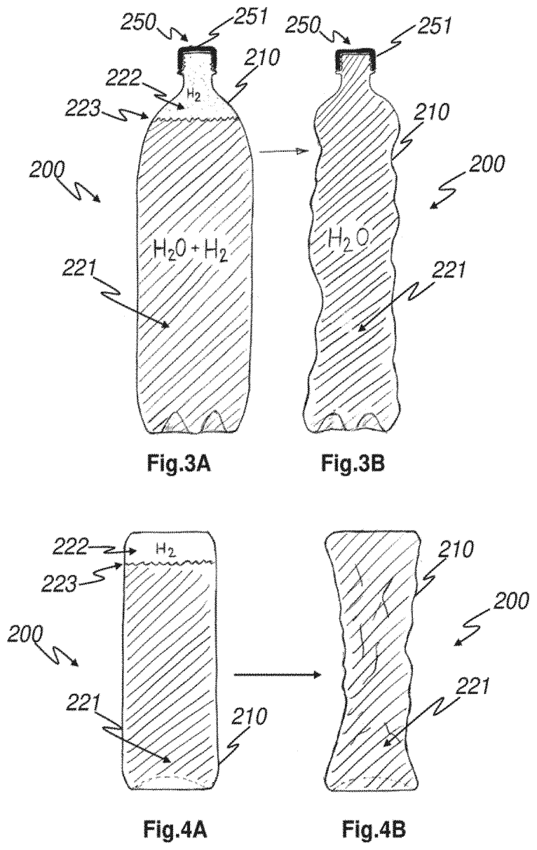

### FIG. 3

FIG. 3 shows a schematic sectional drawing of a foodstuff preserved by a conventional method in a conventional packaging 200.

The packaging 200 differs from the packaging shown in FIG. 1 in that the casing 210 of the packaging 200 is not dimensionally stable under a negative pressure in the hydrogen space 222 of the packaging 200, for example because the packaging 200 is a conventional plastic beverage bottle.

If water H₂O enriched with hydrogen H₂ is filled into the foodstuff space 221 and hydrogen gas H₂ is filled into the hydrogen space 222 in such a packaging (FIG. 3A), the hydrogen gas H₂ can escape from the hydrogen space 222 through the casing 210 of the packaging 200 and/or through the filling opening 250 sealed with the sealing means 251.

Since the casing 210 is not dimensionally stable, it is compressed by the negative pressure generated by the escaping hydrogen gas H₂ in the hydrogen space 222, so that the hydrogen gas H₂ and the hydrogen 112 contained in the water H₂O gradually escape completely until the casing 210 is compressed to the volume of the water H₂O contained therein (FIG. 3B).

### FIG. 4

FIG. 4 shows a schematic sectional drawing of a foodstuff preserved by a conventional method in a conventional packaging 200.

The packaging 200 differs from the packaging shown in FIG. 2 in that the casing 210 of the packaging 200 is not dimensionally stable under a negative pressure in the hydrogen space 222 of the packaging 200, for example because the packaging 200 is a conventional sheet-metal beverage can.

If such a packaging is filled with hydrogen-enriched water in the foodstuff space 221 and hydrogen gas H₂ in the hydrogen space 222 (FIG. 4A), the hydrogen gas H₂ can escape from the hydrogen space 222 through the casing 210 of the packaging 200.

Since the casing 210 is not dimensionally stable, it is compressed by the negative pressure generated by the escaping hydrogen gas H₂ in the hydrogen space 222, so that the hydrogen gas H₂ and the hydrogen contained in the water gradually escape completely until the casing 210 is compressed to the volume of the water contained therein (FIG. 4B).

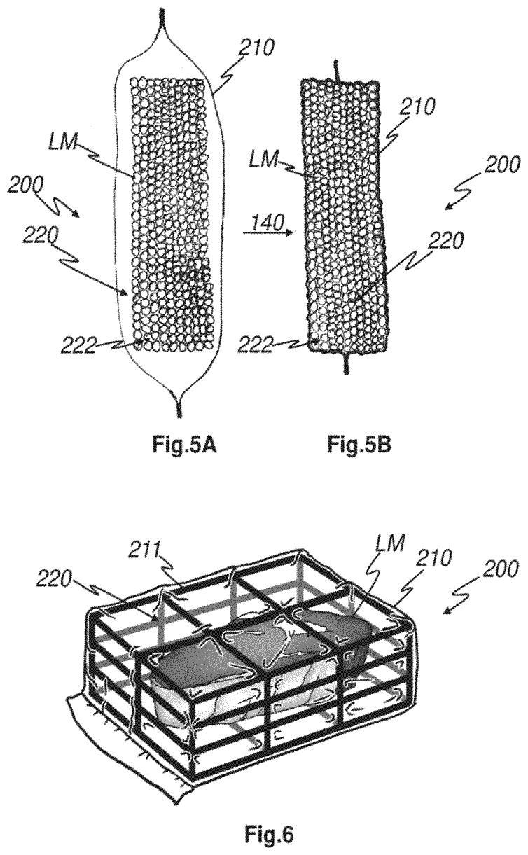

### FIG. 5

FIG. 5 shows a schematic sectional drawing of a foodstuff LM preserved in a further packaging 200 by a method 100 according to the invention.

In contrast to FIGS. 1 and 2, the foodstuff LM in FIG. 3 is a granular foodstuff LM, for example cereal grains. Furthermore, in the case of FIG. 5, the casing 210 of the packaging 200 is not dimensionally stable, but consists for example of a flexible plastic film.

Therefore, the casing 210 is compressed when the negative pressure is generated 140 in the interior space 220. The compression stops as soon as the casing 210 is in contact with the foodstuff LM. Due to the granular structure of the foodstuff LM, dimensionally stable interstices remain within the foodstuff LM, which can serve as a hydrogen space 222 in the sense of the invention.

Analogously to FIGS. 1A and 1B. FIG. 5A shows a state before generating 140 a negative pressure in the interior space 220, and FIG. 5B shows a state after generating 140 the negative pressure.

### FIG. 6

FIG. 6 shows a schematic view of a foodstuff LM preserved in a further packaging 200 by a method 100 according to the invention. The foodstuff LM may be a dimensionally stable foodstuff LM, for example a piece of meat.

In the example illustrated in FIG. 6, the casing 210 of the packaging 200 comprises a flexible material, for example a plastic film, supported by a support structure 211, for example a cage, disposed therein, such that the casing 210 is dimensionally stable under a negative pressure in the interior space 220 of the packaging 200.

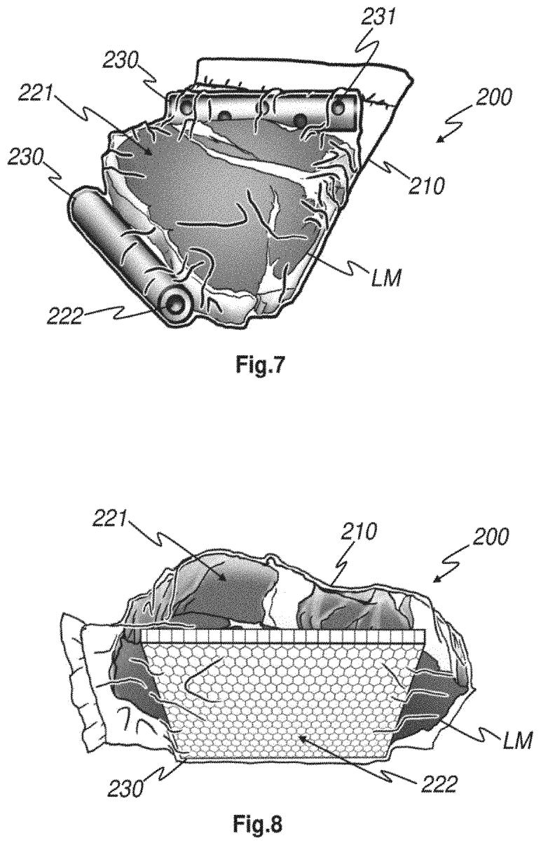

### FIG. 7

FIG. 7 shows a schematic view of a packaging 200 according to the invention. The illustrated packaging 200 comprises a flexible casing 210, for example made of a plastic film, and is particularly suitable for holding a dimensionally stable foodstuff LM, for example a piece of meat. The packaging 200 includes a number of, for example two, sleeves 230. The sleeves 230 contain a hydrogen space 222 for containing hydrogen gas. The sleeves 230 may, for example, be designed as hollow cylinders.

The sleeves 230 are designed to be dimensionally stable under a negative pressure in the hydrogen space 222. The hydrogen space 222 is gas-conductively connected to a foodstuff space 221 for receiving the foodstuff LM. For this purpose, the sleeves 230 may have a number of openings 231 which are preferably designed such that the foodstuff LM cannot enter the hydrogen space 222 through the openings 231, for example because the openings 231 are too small for this purpose or are sealed by a grating or a gas-permeable membrane.

### FIG. 8

FIG. 8 shows a schematic view of a further packaging 200 according to the invention. The shown packaging 200 differs from the packaging shown in FIG. 5 in that the sleeve 230 contained therein has a sponge-like structure or a honeycomb structure and may in particular be designed as a solid foam.

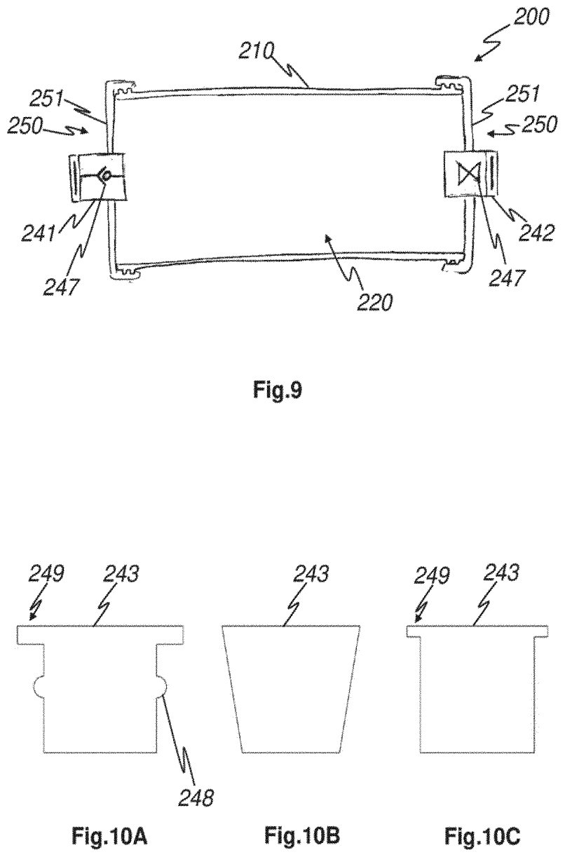

### FIG. 9

FIG. 9 shows a schematic view of a further packaging 200 according to the invention. The illustrated packaging 200 comprises a casing 210 enclosing an interior space 220. In this example, the casing 210 is dimensionally stable under a negative pressure in the interior space 220. For example, the casing 210 may be cylindrically shaped, wherein a filling opening 250 for filling a foodstuff into the interior space 220 is located on at least one end face, in particular on both end faces. The at least one filling opening 250 can be airtightly sealed by a sealing means 251, for example a screw cap.

The packaging 200 comprises a media exchange device, which may comprise, for example, an inlet line 241 for introducing hydrogen gas into the interior space 220 and an outlet line 242 for discharging liquid foodstuff from the interior space 220.

In the example shown, the inlet line 241 is arranged in a first sealing means 251 and comprises a valve 247. The valve 247 is configured, for example, as a check valve that prevents hydrogen gas or foodstuff from flowing back from the interior space 220 into the inlet line 241.

In the illustrated example, the outlet line 242 is disposed in a second sealing means 251 and also comprises a valve 247. The valve 247 may be designed to regulate a flow of the foodstuff from the interior space 220 into the outlet line 242.

### FIG. 10

FIG. 10 shows schematic side views of embodiments of a stopper 243 of a packaging according to the invention. The stopper 243 may, for example, be substantially cylindrical in shape (FIGS. 10A, 10C) or tapered in shape (FIG. 10B). In order to be securely arranged in a filling opening of the packaging 200, the stopper 243 may comprise a bearing portion 249 for resting on an edge of the filling opening. The bearing portion 249 is preferably thin enough to allow the filling opening to be sealed with an associated sealing means while the stopper 243 is in the filling opening.

So as to be able to be sealingly disposed in the filling opening, the stopper 243 may, for example, be made of an elastic material and/or may comprise a ring seal 248 for sealing contact with an edge of the filling opening.

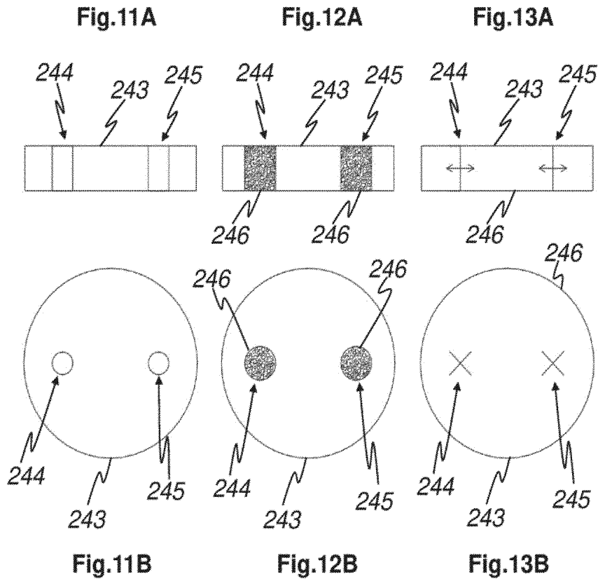

### FIG. 11

FIG. 11 shows schematic representations of a stopper 243 of a packaging according to the invention as a longitudinal section (FIG. 11A) and as a plan view (FIG. 11B). The stopper 243 comprises an inlet opening 244 and an outlet opening 245 for receiving an inlet line and an outlet line of a media exchange device of the packaging.

### FIG. 12

FIG. 12 shows schematic representations of a stopper 243 of a packaging according to the invention as a longitudinal section (FIG. 12A) and as a plan view (FIG. 12B). The stopper 243 comprises an inlet opening 244 and an outlet opening 245 for receiving an inlet line and an outlet line of a media exchange device of the packaging.

The inlet opening 244 and/or the outlet opening 245 may comprise a sealant 246 for sealingly fitting against the inlet line and/or the outlet line. The sealant 246 may comprise, for example, an elastic foam disposed in the particular opening 244, 245.

### FIG. 13

FIG. 13 shows schematic representations of a stopper 243 of a packaging according to the invention as a longitudinal section (FIG. 12A) and as a plan view (FIG. 13B). The stopper 243 comprises an inlet opening 244 and an outlet opening 245 for receiving an inlet line and an outlet line of a media exchange device of the packaging.

The openings 244, 245 may, for example, be designed as slots in the stopper 243. The stopper 243 is made of an elastic material, for example, so that the slots can be widened to accommodate the inlet line and the outlet line, and the stopper 243 can fit tightly against the inlet line and the outlet line as a sealant 246.

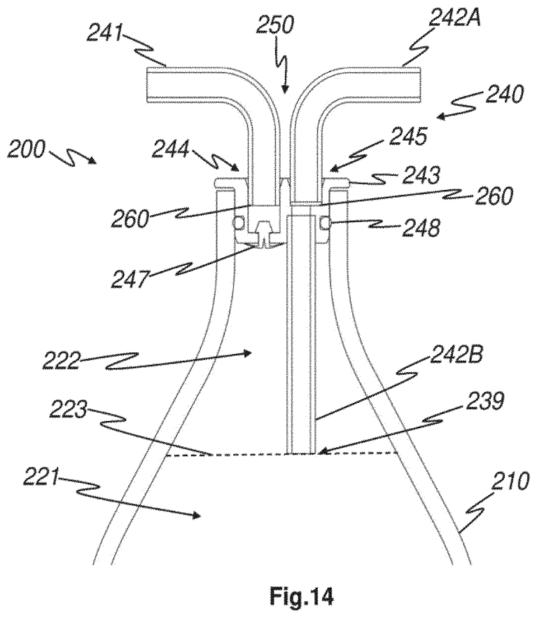

### FIG. 14

FIG. 14 shows a schematic sectional drawing of a packaging 200 according to the invention. The illustrated packaging 200 comprises an airtightly sealable casing 210, for example a beverage bottle, in particular made of glass. In a filling opening 250 for filling a foodstuff, for example water, into an interior space of the casing 210, a stopper 243 is arranged as part of a media exchange device 240. The stopper 243 comprises, for example, a ring seal 248, whereby the stopper 243 sealingly seals the filling opening 250.

The media exchange device 240 comprises an inlet line 241 for introducing hydrogen gas into a hydrogen space 222 in the interior space and an outlet line 242 for discharging foodstuff from the hydrogen space 222. The lines 241, 242 may, for example, be inserted into an inlet opening 244 and an outlet opening 245 of the stopper 243, in each case with a stop 260 defining an insertion depth into the stopper 243.

The outlet line 242 may comprise an outer portion 242A outside the casing 210 and an inner portion 242B in the interior space. A mouth 239 of the outlet line 242 in the interior space defines a contact plane 223, which is horizontal in the drawing, between the hydrogen space 222 and a foodstuff space 221 for receiving the foodstuff in the interior space. In the illustrated example, the hydrogen space 222 and the foodstuff space 221 are directly adjacent to each other at the contact plane 223, without a physical barrier.

Preferably, at least the inlet line 241 and the outer portion 242A of the outlet line 242 are releasably connected, for example wedged, to the stopper 243. This allows the inlet line 241 and the outer portion 242A to be removed without removing the stopper 243 from the filling opening 250. Thereafter, a filling opening 250 can be airtightly sealed with a sealing means, for example a screw cap commonly used for beverage bottles.

The inlet line 241 may comprise a valve 247, in particular a check valve, which prevents hydrogen gas or foodstuff from flowing back from the interior space into the inlet line 241.

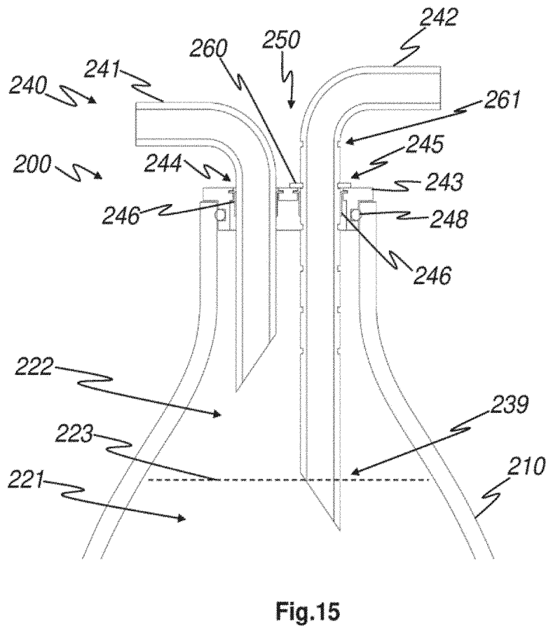

### FIG. 15

FIG. 15 shows a schematic sectional drawing of a further packaging 200 according to the invention. The packaging 200 shown in FIG. 15 differs from the packaging 200 shown in FIG. 12 in the following respects:

In this example, the inlet line 241 and the outlet line 242 are passed through the inlet opening 244 and the outlet opening 245 of the stopper 243, the stopper 243 having a sealant 246, for example sealing lips, to sealingly connect the lines 241, 242 to the stopper 243.

In particular, the outlet line 242 may comprise a stop 260, for example a snap ring, which allows the outlet line 242 to pass through the outlet opening 245 only to a predefined depth. Preferably, the stop 260 is attached to the outlet line 242 such that different predefined depths can be set. For this purpose, the outlet line 242 may comprise, for example, a plurality of grooves 261 spaced apart from each other along the outlet line 242 for mounting the stop 260.

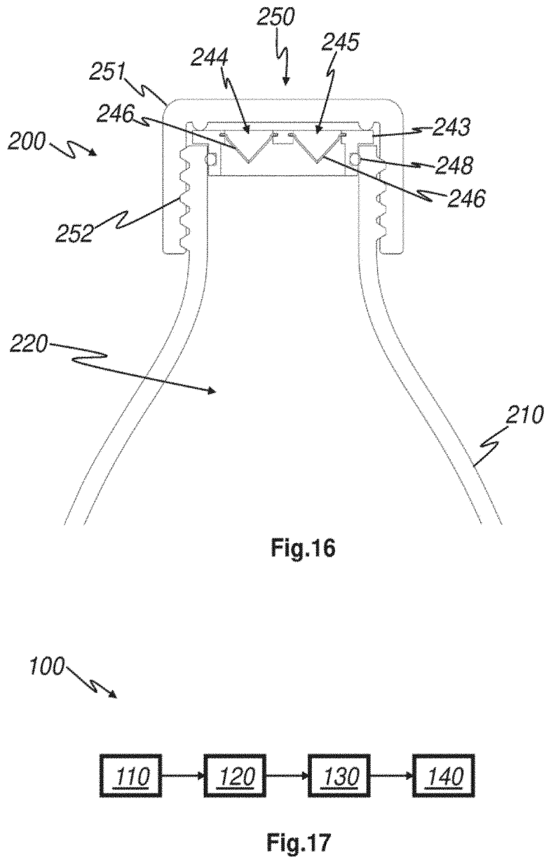

### FIG. 16

FIG. 16 shows a further schematic sectional drawing of the packaging 200 from FIG. 13. In contrast to the illustration in FIG. 13, here the inlet line 241 and the outlet line 242 are removed from the stopper 243. This allows a sealing means 251, for example a screw cap commonly used for beverage bottles, to airtightly seal the filling opening 250, while the stopper 243 remains in the filling opening 250.

In FIG. 15, it is further visible that the sealant 246 arranged in the inlet opening 244 and in the outlet opening 245 can seal each opening 244, 245 once the inlet line and the outlet line are removed. This can prevent hydrogen gas from escaping from the interior space 220 at least temporarily until the sealing means 251 is mounted on the filling opening 250.

### FIG. 17

FIG. 17 shows a schematic representation of a method 100 according to the invention. The shown method 100 comprises a filling 110 of a foodstuff into a foodstuff space in an interior space of a packaging which can be airtightly sealed by a casing. The method 100 comprises, for example after the filling 110, introducing 120 hydrogen gas into a hydrogen space in the interior space, which hydrogen space is connected to the foodstuff space at least in a gas-conducting manner. The method 100 comprises an airtight sealing 130 of the casing after the filling 110 and introduction 120. The method 100 comprises, for example after the sealing 130, a generation 140 of a negative pressure at least in the hydrogen space relative to an environment of the packaging, wherein the casing or a sleeve surrounding the hydrogen space is dimensionally stable under the negative pressure.

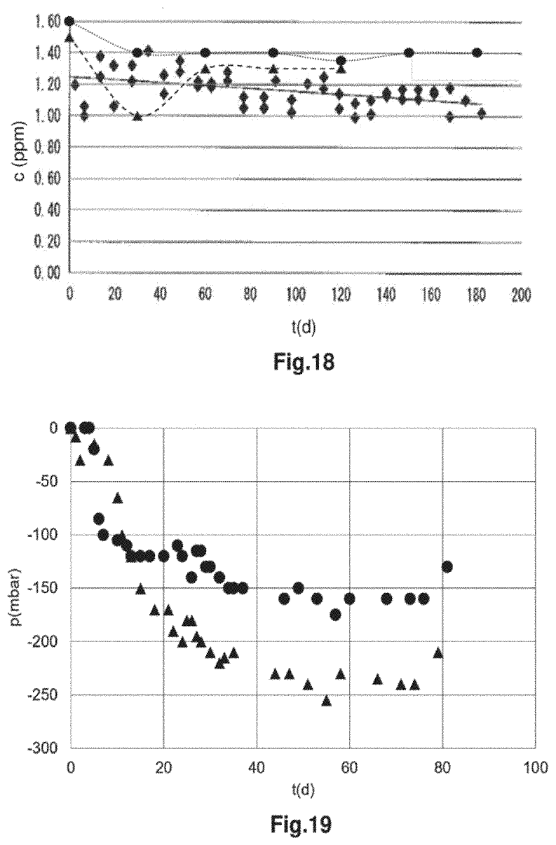

### FIG. 18

FIG. 18 shows a hydrogen content c in ppm of water preserved by a method according to the invention depending on a storage period t in days (d).

The graph shows measurement results from two independent experiments (circles with dotted line, triangles with dashed line). The lines in each case only serve to make them easier to recognise. The hydrogen content is determined by titration with methylene blue in solution with platinum nanoparticles (H2 Sciences Inc., USA). In this method, hydrogen can dock to the methylene blue via the platinum particles, which serve as a catalyst, thus changing its colour from blue to transparent.

For the experiments, a volume of approximately 50 mL of hydrogen gas is introduced into each glass bottle filled with water and having a total volume of 1 L. The hydrogen gas is then added to the bottle. Before filling the bottle, the water has a hydrogen content of 1.6 ppm. The glass bottles are standard beverage bottles which, after the hydrogen gas has been introduced, are airtightly sealed with their associated plastic screw caps.

The hydrogen-enriched water is prepared beforehand in a sufficiently large water dispenser so that the water has the same initial hydrogen content for all bottles in a test series. Distilled, non-degassed water is used. A separate bottle is used for each measuring point. The bottles are stored at a minimum of 16° C. and in the dark.

For comparison, the graph also shows data for the storage of hydrogen-enriched water using a prior art method (US20180213825A1, FIG. 8) with an associated regression line (diamonds with solid line).

With the method according to the invention, there is initially, especially within the first 30 days, a similarly strong decrease in the hydrogen content as with the prior art method. Thereafter, however, the decrease with the method according to the invention slows down considerably and seems to stabilise at a value of about 1.3 ppm to 1.4 ppm, whereas it continues unabated with the prior an method. Thus, with a longer storage period, for example at least 180 days, a higher hydrogen content is achieved with the method according to the invention than with the prior art method.

### FIG. 19

FIG. 19 shows a pressure p in mbar in a packaging of water preserved by a method according to the invention depending on a storage period t in days (d).

The graph shows measurement results from two independent tests (circles, triangles). The pressure p inside the packaging relative to an ambient pressure of the packaging is measured by bottle pressure gauges which are screwed onto the bottles or fastened with swing stoppers.

The water is filled and stored as described in FIG. 18.

Like the hydrogen content shown in FIG. 18, the pressure in the packaging also decreases relatively quickly initially, especially within the first 30 days. After that, the decrease in pressure slows down considerably, as does the decrease in hydrogen content, and appears to stabilise at an equilibrium value of about −150 mbar to −250 mbar relative to ambient pressure.

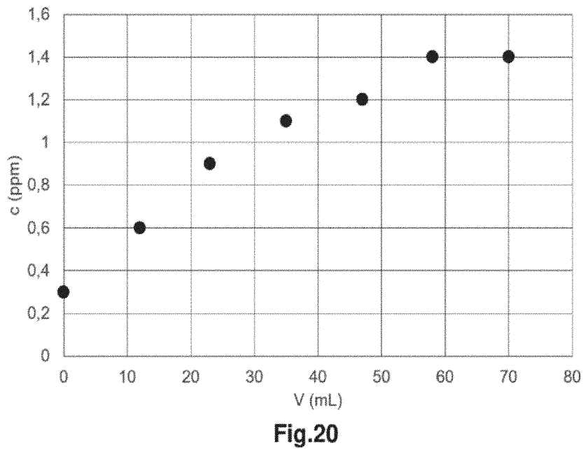

### FIG. 20

FIG. 20 shows a hydrogen content c in ppm of water preserved by a method according to the invention depending on a filled hydrogen volume V in mL after a storage period of 44 days.

The hydrogen content is determined as described for FIG. 18. The specified hydrogen volume V of hydrogen gas is introduced to water with an initial hydrogen content c of 1.6 ppm into a bottle with a total volume of 1 L, the bottle being completely filled with water before this introduction.

The further filling and storage conditions correspond to those described in FIG. 18.

The graph shows that a certain minimum volume of hydrogen gas of about 50 mL to 60 mL in the example shown is necessary to obtain a maximum hydrogen content of the water during storage. A further increase in the hydrogen volume does not lead to an increase in the hydrogen content and should therefore be avoided for economic and safety reasons.

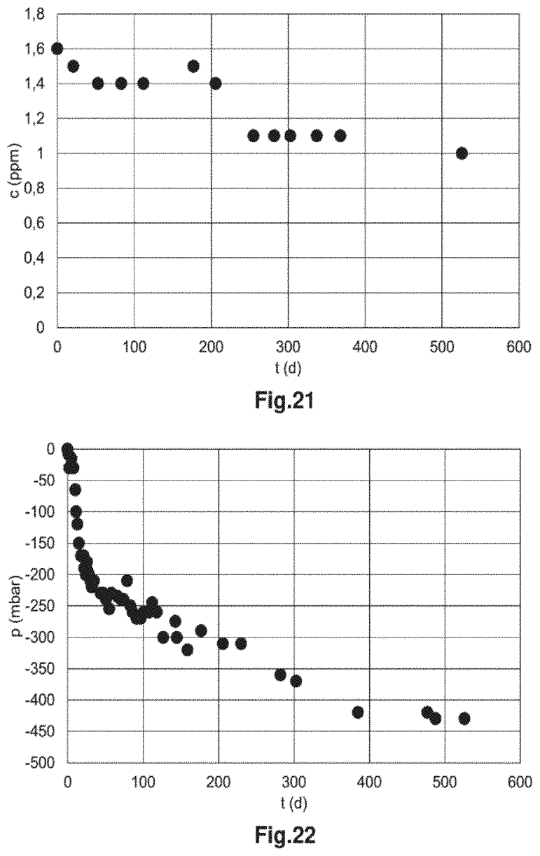

### FIG. 21

FIG. 21 shows a hydrogen content c in ppm of water preserved by a method according to the invention depending on a storage period t in days (d) in experiments performed over a longer period of time from the test series already shown in FIG. 18.

The hydrogen content is determined as described for FIG. 18.

For the experiments, a volume of approximately 60 mL of hydrogen gas is introduced into each glass bottle filled with water and having a total volume of 1 L. Before filling the bottle, the water has a hydrogen content of 1.6 ppm. The glass bottles are standard beverage bottles which, after the hydrogen gas has been introduced, are airtightly sealed with their associated plastic screw caps.

The water enriched with hydrogen is produced beforehand in a sufficiently large water dispenser, so that the water has the same initial hydrogen content for all bottles in the test series. Distilled, non-gassed water is used. A separate bottle is used for each measuring point. The bottles are stored at a temperature between 16° C. and 26° C. and at an ambient pressure of 992 mbar to 1034 mbar in the dark.

It can be seen in FIG. 21 that the hydrogen content, as already in FIG. 18, stabilises after an initial decrease. The decrease occurs here approximately within the first 0.5 years of storage down to a value of approximately 1.1 ppm, which is then maintained at least up to a storage period of approximately 1.5 years. The water enriched with hydrogen can thus be maintained for substantially longer than with storage methods from the prior art.

### FIG. 22

FIG. 22 shows a pressure p in mbar in a packaging of water preserved by a method according to the invention depending on a storage period t in days (d) in experiments performed over a longer period of time from the test series already shown in FIG. 19.

The filling and storing of the water are as described for FIG. 21. The pressure p inside the packaging relative to an ambient pressure of the packaging is measured by bottle pressure gauges which are screwed onto the bottles instead of the associated cap or are fastened with swing stoppers.

The pressure in the packaging initially decreases relatively quickly as in FIG. 19, in particular during the first half year of storage. The decrease of the pressure then significantly slows, and appears to approach an equilibrium value of about −500 mbar

List of Reference Signs

| | |
|---|---|
| 100 | Method |
| 110 | Filling |
| 120 | Introduction |
| 130 | Sealing |
| 140 | Generation |
| 200 | Packaging |
| 210 | Sleeve |
| 211 | Support structure |
| 220 | Interior space |
| 221 | Foodstuff space |
| 223 | Contact plane |
| 230 | Sleeve |
| 231 | Opening |
| 239 | Mouth |
| 240 | Media exchange device |
| 214 | Inlet line |
| 242 | Outlet line |
| 242A | Outer portion |
| 242B | Inner portion |
| 243 | Stopper |
| 244 | Inlet opening |
| 245 | Outlet opening |
| 246 | Sealant |
| 247 | Valve |
| 248 | Ring seal |
| 249 | Bearing portion |
| 250 | Filling opening |
| 251 | Sealing means |
| 252 | Thread |
| 260 | Stop |
| 26 | Groove |
| c | Hydrogen content |
| H2 | Hydrogen |
| H2O | Water |
| LM | Foodstuff |
| p | Pressure |
| t | Storage period |
| V | Hydrogen volume |

1-30. (canceled)

31. A method (100) for preserving a foodstuff in a hydrogen atmosphere in a packaging comprising
a) an interior space (220) enclosed by a hydrogen-permeable and airtightly sealable casing (210),
b) the interior space (220) comprising a foodstuff space (221) for receiving the foodstuff and a hydrogen space (222) for receiving hydrogen gas,
c) the foodstuff space (221) and the hydrogen space (222) being connected to each other in a gas-conducting and liquid-conducting manner, and
d) the casing (210) being dimensionally stable under a negative pressure in the hydrogen space (222) relative to an environment of the packaging (200) of at least 400 mbar,
for following steps:
e) filling (110) the foodstuff at least into the foodstuff space (221),
f) introducing (120) hydrogen gas at least into the hydrogen space (222),
g) airtightly sealing (130) the casing (210) after the filling (110) and introduction (120), and
h) generating (140) a negative pressure at least in the hydrogen space (222) relative to an environment of the packaging (200),
i) the generation (140) of the negative pressure comprising diffusing hydrogen gas through the casing (210) into the environment of the packaging (200) after the casing (210) has been airtightly sealed (130),
j) the generated negative pressure relative to an environment of the packaging (200) being at least 200 mbar,
k) the casing (210) of the packaging (200) being dimensionally stable under the generated negative pressure.

32. The method (100) according to claim 31, wherein the generated negative pressure relative to an environment of the packaging (200) is from 200 mbar to 500 mbar, preferably 200 mbar to 300 mbar, the casing (210) of the packaging (200) being dimensionally stable under the generated negative pressure

33. The method (100) according to claim 31, wherein the generated negative pressure relative to an environment of the packaging (200) is at least 400 mbar, the casing (210) of the packaging (200) being dimensionally stable under the generated negative pressure.

34. The method according to claim 31, wherein the generation (140) of the negative pressure comprises pumping air out of the interior space (220) prior to the airtight sealing (130) of the casing (210) and prior to the introduction (120) of the hydrogen gas.

35. The method (100) according to claim 31, wherein
a) the foodstuff space (221) and the hydrogen space (222) for the foodstuff are conductively connected to each other,
b) the filling (110) of the foodstuff comprises completely filling the interior space (220) with the foodstuff, and
c) the introduction (120) of the hydrogen gas takes place after the filling (110) and comprises a displacement of the foodstuff from the hydrogen space (222).

36. The method (100) according to claim 31, wherein
a) the introduction (120) of the hydrogen gas comprises a filling (110) of a hydrogen-enriched foodstuff,
b) the foodstuff being saturated with hydrogen and/or containing no other gases.
